(19) United States
(12) Patent Application Publication
(10) Pub. No.: US 2019/0027832 A1
(43) Pub. Date: Jan. 24, 2019

(54) ANTENNA MOUNTS AND METHODS FOR ADJUSTING SAME

(71) Applicant: CommScope Technologies LLC, Hickory, NC (US)

(72) Inventors: Ian Thomas Renilson, Fife (GB); David John Walker, Edinburgh (GB); Thomas Cunningham Tulloch, Fifi (GB)

(21) Appl. No.: 16/068,227

(22) PCT Filed: Feb. 15, 2017
(86) PCT No.: PCT/US2017/017945

§ 371 Date: Jul. 5, 2018

Related U.S. Application Data
(60) Provisional application No. 62/296,880, filed on Feb. 18, 2016.

(51) Int. Cl. H01Q 15/16; H01Q 1/12; H01Q 3/08

(52) U.S. Cl. CPC H01Q 15/16; H01Q 3/08; H01Q 1/125; H01Q 1/1228

(57) ABSTRACT

A method of adjusting the pointing angle of an antenna includes mounting an antenna on a mounting structure with an antenna mount that includes a clamp member fixed to the mounting structure, a first adjustment bracket pivotally attached to the clamp member, and a second adjustment bracket pivotally attached to the first adjustment bracket, the antenna being mounted to the second adjustment bracket. The first and/or second adjustment brackets includes an access hole for receiving a toothed hand tool. One of the clamp member, the first adjustment bracket and the second adjustment bracket includes a toothed section. A toothed hand tool is inserted through the access hole to engage the toothed section; and rotated to pivot the first adjustment bracket relative to the clamp member or the second adjustment bracket relative to the first adjustment bracket. The pivoted bracket is secured to set the azimuth or elevation angle.

### RELATED APPLICATION

The present application claims priority from and the benefit of U.S. Provisional Patent Application No. 62/296,880, filed Feb. 18, 2016, the disclosure of which is hereby incorporated herein in its entirety.

### FIELD OF THE INVENTION

The invention relates to antennas. More particularly, the invention relates to an antenna alignment adjustment assembly that enables fine adjustment in a simplified and compact structure.

### BACKGROUND

Point-to-point antennas typically require fine adjustment for alignment (in both elevation and azimuth) between transmit and receive antennas. Conventionally this is done by incorporating adjustment mechanisms into the antenna—usually two mechanisms—which are redundant after the antenna is aligned. Smaller antennas can be aligned by manually moving the antenna before clamping in place. Such adjustment reduces the cost of the antenna mount, but accurate alignment can be difficult, and this technique is not feasible for high frequency antennas. Therefore, complex mounts are required for a range of small antennas, despite the fact that the adjustment mechanism may only be required for the highest frequencies.

Alignment mechanisms may be incorporated into the mounting arrangement of the antenna. Antenna mounts relying upon arc slots for controlled angular movement about a center axis of the arc slot are known. Fine adjustment of an arc slot-type antenna mount may be problematic as the fasteners associated with locking the mount at the desired position along the arc slot may have a significant amount of “slop” when loosened enough to enable movement, which can impede tightening of the mount at the desired orientation and/or fine adjustment of the orientation. The use of finely threaded rod and boss arrangements to drive the mount along the arc slot, including a bias member to remove any slop, is also known, for example as disclosed in U.S. Pat. No. 7,046,210 to Brooker et al. However, the multiple additional elements and clearance therebetween required for this type of arrangement may increase the size of the mount and/or overly complicate manufacture of the mount.

Antenna mounts utilizing gears are also known. However, gears and structure required for maintaining the gears in aligned engagement with each other may similarly increase the size, complexity and cost of the of the mount.

Antennas may be installed at exposed locations high atop towers. Improved installation and/or maintenance personnel safety is a constant concern of the radio tower industry. Therefore, installation and/or adjustment procedures with a reduced number of steps and low installer force requirements may be desirable.

### SUMMARY

As a first aspect, embodiments of the invention are directed to a method of adjusting the pointing angle of an antenna. The method comprises: mounting an antenna on a mounting structure with an antenna mount, the antenna mount including a clamp member fixed to the mounting structure, a first adjustment bracket pivotally attached to the clamp member, and a second adjustment bracket pivotally attached to the first adjustment bracket, the antenna being mounted to the second adjustment bracket, wherein at least one of the first and second adjustment brackets includes an access hole for receiving a toothed hand tool, and wherein at least one of the clamp member, the first adjustment bracket and the second adjustment bracket includes a toothed section; inserting a toothed hand tool through the access hole to engage the toothed section; rotating the hand tool to pivot (a) the first adjustment bracket relative to the clamp member or (b) the second adjustment bracket relative to the first adjustment bracket; and securing the pivoted first or second adjustment bracket in position to set the azimuth angle or elevation angle of the antenna.

As a second aspect, embodiments of the invention are directed to a method of adjusting an azimuth angle and an elevation angle of an antenna, comprising: mounting an antenna on a mounting structure with an antenna mount, the antenna mount including a clamp member fixed to the mounting structure, an azimuth adjustment bracket pivotally attached to the clamp member, and an elevation adjustment bracket pivotally attached to the azimuth adjustment bracket, the antenna being mounted to the elevation adjustment bracket, wherein the azimuth adjustment bracket includes first and second access holes for receiving a toothed hand tool, and wherein each of the clamp member and the elevation adjustment bracket includes a toothed section; inserting a toothed hand tool through the first access hole to engage the toothed section of the clamp member; rotating the hand tool to pivot the azimuth adjustment bracket relative to the clamp member to adjust the azimuth angle of the antenna; inserting the toothed hand tool through the second access holed to engage the toothed section of the elevation engagement bracket to adjust the elevation angle of the antenna; rotating the hand tool to pivot the elevation bracket relative to the azimuth adjustment bracket; and securing the pivoted azimuth adjustment bracket and the pivoted elevation adjustment bracket in position to set the azimuth angle and elevation angle of the antenna.

As a third aspect, embodiments of the invention are directed to an antenna mount, comprising: a clamp member configured to be fixed to a mounting structure, the clamp member including a first toothed section; an azimuth adjustment bracket pivotally attached to the clamp member at a first pivot; and an elevation adjustment bracket pivotally attached to the azimuth adjustment bracket at a second pivot and including a second toothed section, the elevation adjustment bracket configured to be fixed to an antenna. The azimuth adjustment bracket includes first and second access holes for receiving a toothed hand tool and providing access for the hand tool to, respectively, the first and second toothed sections.

As a fourth aspect, embodiments of the invention are directed to an antenna mount, comprising: a clamp member configured to be fixed to a mounting structure, the clamp member including a toothed section; an azimuth adjustment bracket pivotally attached to the clamp member at a first pivot; and an elevation adjustment bracket pivotally attached to the azimuth adjustment bracket at a second pivot, the elevation adjustment bracket configured to be fixed to an antenna. The azimuth adjustment bracket includes an access hole for receiving a toothed hand tool and providing access for the hand tool to the toothed section.

As a fifth aspect, embodiments of the invention are directed to a method of adjusting the pointing angle of a transmitting and/or receiving device, comprising: mounting the device on a mounting structure with a mount, the mount including a clamp member fixed to the mounting structure, a first adjustment bracket pivotally attached to the clamp member, and a second adjustment bracket pivotally attached to the first adjustment bracket, the device being mounted to the second adjustment bracket, wherein at least one of the first and second adjustment brackets includes an access hole for receiving a toothed hand tool, and wherein at least one of the clamp member, the first adjustment bracket and the second adjustment bracket includes a toothed section; inserting a toothed hand tool through the access hole to engage the toothed section; rotating the hand tool to pivot (a) the first adjustment bracket relative to the clamp member or (b) the second adjustment bracket relative to the first adjustment bracket; and securing the pivoted first or second adjustment bracket in position to set the vertical angle or horizontal angle of the device.

### BRIEF DESCRIPTION OF THE FIGURES

FIG. 1 is a top perspective view of an antenna mounted to a pole via an antenna mount according to embodiments of the invention.

FIG. 2 is a top view of a torx tool that can be used to adjust the position of the antenna of FIG. 1.

FIG. 3 is an enlarged top perspective view of an azimuth adjustment mechanism of the antenna mount of FIG. 1 with the torx tool of FIG. 2 inserted.

FIG. 3A is an enlarged top perspective view of an azimuth adjustment mechanism for use with the antenna mount of FIG. 1 according to alternative embodiments of the invention with the torx tool of FIG. 2 inserted.

FIG. 3B is an enlarged top perspective view of an azimuth adjustment mechanism for use with the antenna mount of FIG. 1 according to further alternative embodiments of the invention with the torx tool of FIG. 2 inserted.

FIG. 4 is an enlarged bottom perspective view of the azimuth adjustment mechanism of FIG. 3 with the torx tool of FIG. 2 inserted.

FIG. 4A is an enlarged bottom perspective view of the azimuth adjustment mechanism of FIG. 3A with the torx tool of FIG. 2 inserted.

FIG. 4B is an enlarged bottom perspective view of the azimuth adjustment mechanism of FIG. 3B with the torx tool of FIG. 2 inserted.

FIG. 5 is an enlarged top perspective view of the elevation adjustment mechanism of the antenna mount of FIG. 1 with the torx tool of FIG. 2 inserted.

FIG. 6 is an enlarged top perspective view of the elevation adjustment mechanism of FIG. 5 with the main panel removed for clarity.

FIG. 7 is a top perspective view of an antenna mounted to a pole via an antenna mount according to alternative embodiments of the invention.

FIG. 8 is an enlarged top perspective view of the azimuth adjustment mechanism of the antenna mount of FIG. 7 with a spline tool inserted.

FIG. 9 is a top view of the clamp member of the antenna mount of FIG. 7.

FIG. 10 is a schematic top view of the clamp member of FIG. 9 showing its capability to clamp poles of different diameters.

FIG. 11 is a top view of the antenna, pole and antenna mount of FIG. 7 showing the gentle radiusing of the clamp member to reduce stress on the straps holding the antenna mount to the pole.

FIG. 12 is a top view of the antenna, pole and antenna mount of FIG. 7 showing an undesirable relative position of the pole and antenna.

FIG. 13 is a top view of the antenna, pole and antenna mount of FIG. 7 showing how the arrangement of the teeth on the clamping member prevents the rotation of the antenna to the undesirable position of FIG. 12.

FIG. 14 is a top view of an alternative clamp member for the antenna mount of FIG. 7 with a protrusion adjacent the outermost teeth of the clamp member.

FIG. 15 is a top view of another alternative clamp member for the antenna mount of FIG. 7 with a lobe adjacent the teeth that engages the azimuth adjustment bracket.

FIG. 16 is a perspective view of still another alternative clamp member for the antenna mount of FIG. 7 with pins that engage the azimuth adjustment bracket.

FIG. 17 is a top view of the antenna mount of FIG. 7 showing exemplary dimensions used in calculating the relationship between tool movement and angular adjustment of the antenna.

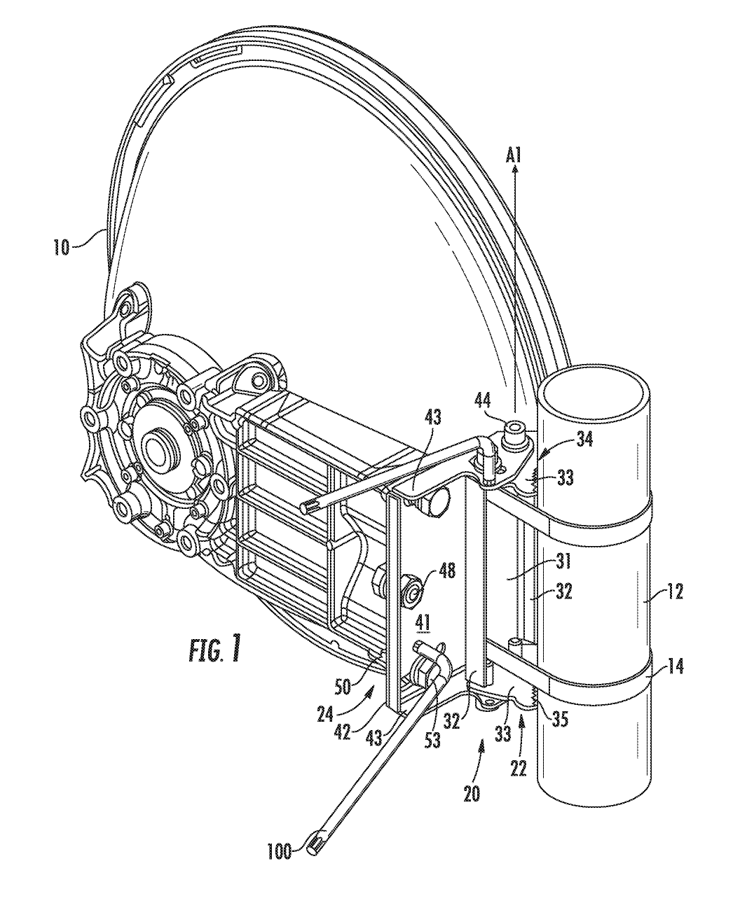

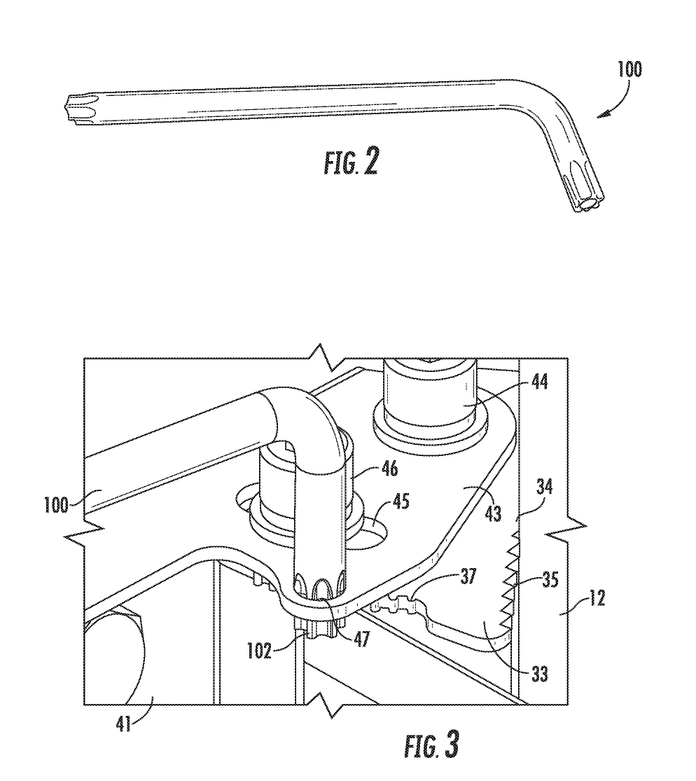

### DETAILED DESCRIPTION

The present invention is described with reference to the accompanying drawings, in which certain embodiments of the invention are shown. This invention may, however, be embodied in many different forms and should not be construed as limited to the embodiments that are pictured and described herein; rather, these embodiments are provided so that this disclosure will be thorough and complete, and will fully convey the scope of the invention to those skilled in the art. It will also be appreciated that the embodiments disclosed herein can be combined in any way and/or combination to provide many additional embodiments.

Unless otherwise defined, all technical and scientific terms that are used in this disclosure have the same meaning as commonly understood by one of ordinary skill in the art to which this invention belongs. The terminology used in the below description is for the purpose of describing particular embodiments only and is not intended to be limiting of the invention. As used in this disclosure, the singular forms “a”, “an” and “the” are intended to include the plural forms as well, unless the context clearly indicates otherwise. It will also be understood that when an element (e.g., a device, circuit, etc.) is referred to as being “connected” or “coupled” to another element, it can be directly connected or coupled to the other element or intervening elements may be present. In contrast, when an element is referred to as being “directly connected” or “directly coupled” to another element, there are no intervening elements present.

Referring now to the figures, an antenna 10 is mounted to a pole 12 via an antenna mount 20 according to embodiments of the invention. The antenna 10 can be of conventional construction (for example, it may be a parabolic or flat panel antenna) and need not be described in detail herein. The pole 12 may be any structure upon which an antenna is typically mounted, such as a leg of an antenna tower, a monopole, or the like. The antenna mount 20 is fixed to the pole 12 via straps 14 that can be inserted through holes in the antenna mount 20.

The illustrated antenna mount 20 includes three separate mounting components: a clamp bracket 22 that mounts the remainder of the antenna mount 20 to the pole 12; an azimuth adjustment bracket 24 that can pivot relative to the clamp bracket 22 to enable azimuth angle adjustment; and an elevation adjustment bracket 26 fixed to the antenna 10 that can pivot relative to the azimuth adjustment bracket 24 to enable elevation angle adjustment. These components are described in greater detail below.

The clamp bracket 22 includes a main panel 31, two side walls 32, and two end walls 33. The main panel 31 includes holes (not visible in the figures) that receive the straps 14 for mounting of the antenna mount 20 to the pole 12. Each of the end walls 33 is generally triangular and includes a clamping edge 34 with teeth 35 to enhance clamping of the antenna mount 20 to the pole 12. Each of the end walls 33 also includes an arcuate toothed section 36 with teeth 37 on one edge. Two mounting holes (not visible in the figures) are also present in each end wall 33. Although the clamp bracket 22 is illustrated herein, any clamp member that enables the mount to be fixed to a support may be suitable for use.

The azimuth adjustment bracket 24 has a main panel 41, a side wall 42 and two end walls 43. Each of the end walls 43 includes a mounting hole (not visible) through which a bolt 44 extends; the bolt 44 further extends through one of the mounting holes in the end wall 33 of the clamp bracket 22. An arcuate slot 45 is positioned on each end wall 43 to align with the other of the mounting holes of the clamp bracket 33; a bolt 46 extends through the slot 45 and the other mounting hole of the clamp bracket 22. An access hole 47 is located in a small extension in each end wall 43 adjacent the teeth 37 of the toothed section 36 of the end wall 33.

In its main panel 41, the azimuth elevation bracket 24 includes a central mounting hole (not visible) through which a bolt 48 extends. The bolt 48 is received in a hole 51 on a panel 52 in an HMR 50 mounted to the antenna 10 (see FIG. 6). Two arcuate slots 49 are located at opposite ends of the main panel 41. A bolt 53 extends through each slot 49 and is received in a hole 57 in the HMR 50. An access hole 56 is located near each slot 49.

The elevation adjustment bracket 26 (see FIG. 6) is mounted to the HMR 50. The elevation adjustment bracket 26 has an arcuate slot 54 with teeth 55 on one edge.

The antenna 10 is installed by strapping the antenna 10 and antenna mount 20 to the pole 12 with the straps 14. The bolts 44, 46 that attach the azimuth adjustment bracket 24 to the clamp bracket 22 are loosened somewhat to enable the azimuth adjustment bracket 24 to pivot relative to the clamp bracket 22 about a substantially vertical axis A1 that extends through the bolts 44.

An L-shaped torx tool 100 with standard teeth 102 is inserted into one of the access holes 47. In some embodiments, the access holes 47 are sized to be substantially similar in radius/diameter to that of the toothed ends of the torx tool 100 (e.g., a radius of 3 mm). Insertion of the tool 100 into the access hole 47 causes the teeth 102 of the torx tool 100 to engage the teeth 37 of the toothed section 36 of the end wall 33 of the clamp bracket 22. Rotation of the torx tool 100 about a vertical axis causes the azimuth adjustment bracket 24 to pivot about the axis A1, thereby enabling the azimuth angle of the mounted antenna 10 to be adjusted. Once the proper azimuth angle is achieved, the bolts 44, 46 can be tightened to secure the antenna 10 in place.

Also, the bolts 48, 53 that attach the azimuth adjustment bracket 24 to the HMR 50 of the antenna 10 are loosened to enable the elevation adjustment brackets 26 (and, in turn, the antenna 10 mounted thereto via the HMR 50) to pivot about a substantially horizontal axis A2 defined by the bolt 48. The torx tool 100 can be inserted into the access hole 56 of the azimuth adjustment bracket 24, which engages the teeth 102 of the torx tool 100 with the teeth 55 of the slot 54 of the elevation adjustment bracket 26. Rotation of the torx tool 100 rotates the antenna 10 about the axis A2 to adjust its elevation angle. Once the proper elevation angle is reached, the bolts 48, 53 can be tightened to secure the antenna 10 in place.

Those of skill in this art will appreciate that other variations of the antenna mount 20 are suitable. For example (and as discussed in one form below), the antenna mount may be configured such that only one of the adjustment brackets is adjusted with the torx tool or other hand tool, with the other of the adjustment brackets being adjusted manually. In some variations, one or more of the toothed sections may be located on the azimuth adjustment bracket, with the access hole(s) located on the clamp member and/or elevation adjustment bracket. In some embodiments, an elevation adjustment bracket may be attached directly to the clamp member, with the azimuth adjustment bracket attached to the elevation adjustment bracket and to the antenna. Although bolts are shown to serve as pivot points and securing members, other components may be used; for example, rivets or the like may be used as pivot components, and screws or clamps may be used as fasteners to secure the brackets in place once they have been adjusted. Other variations will be recognized by those of skill in this art.

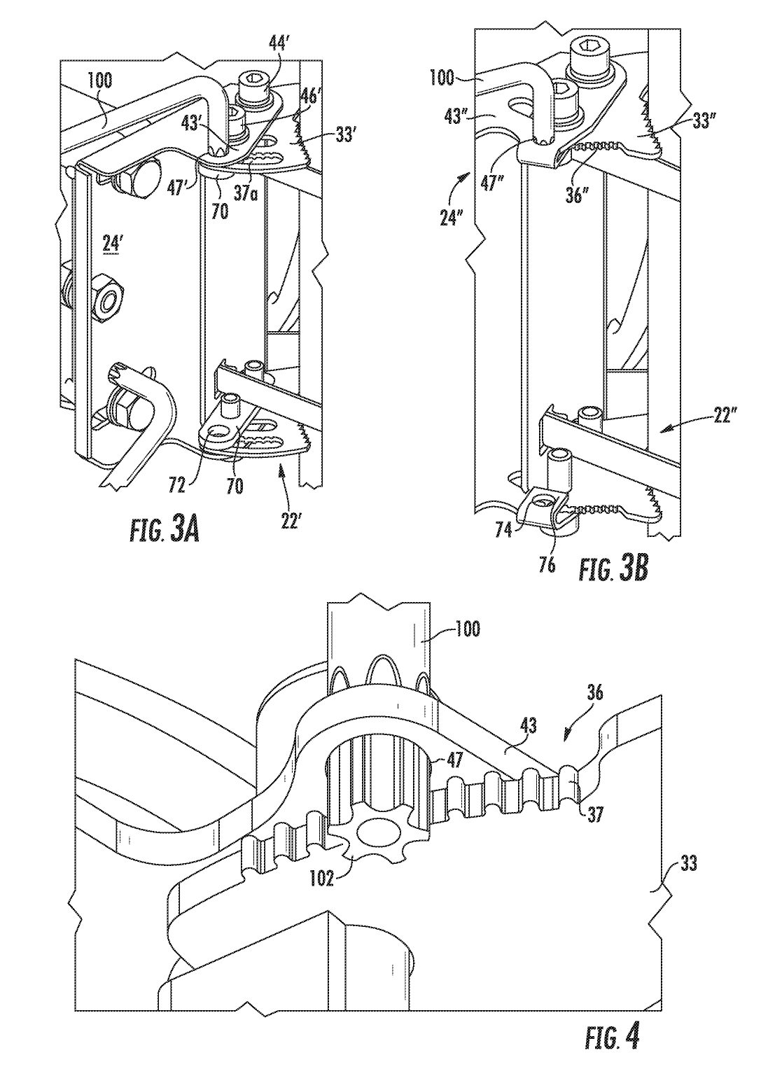

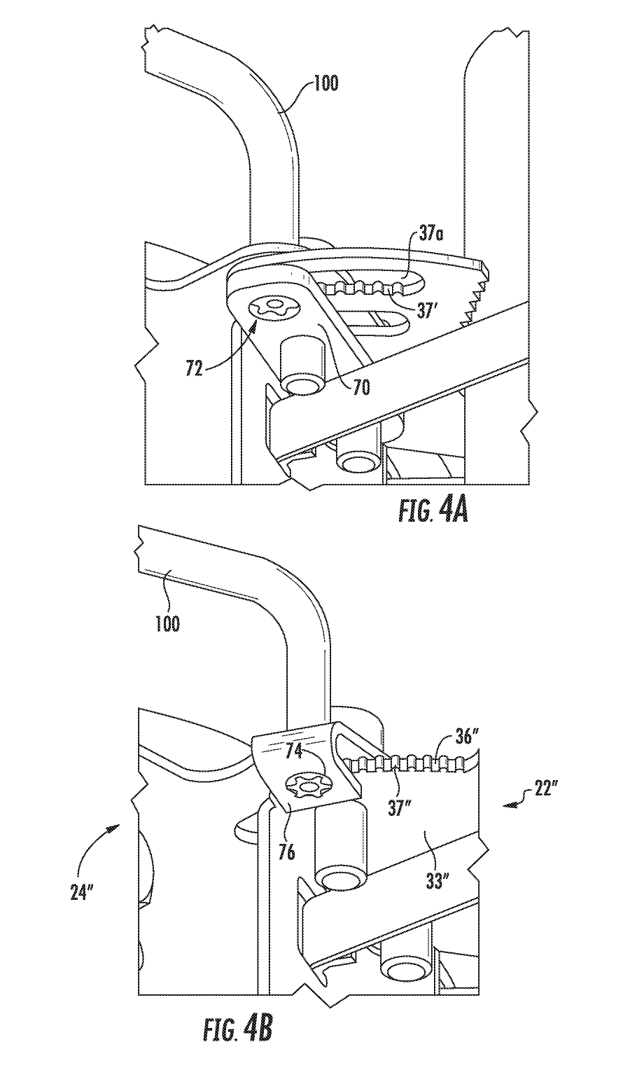

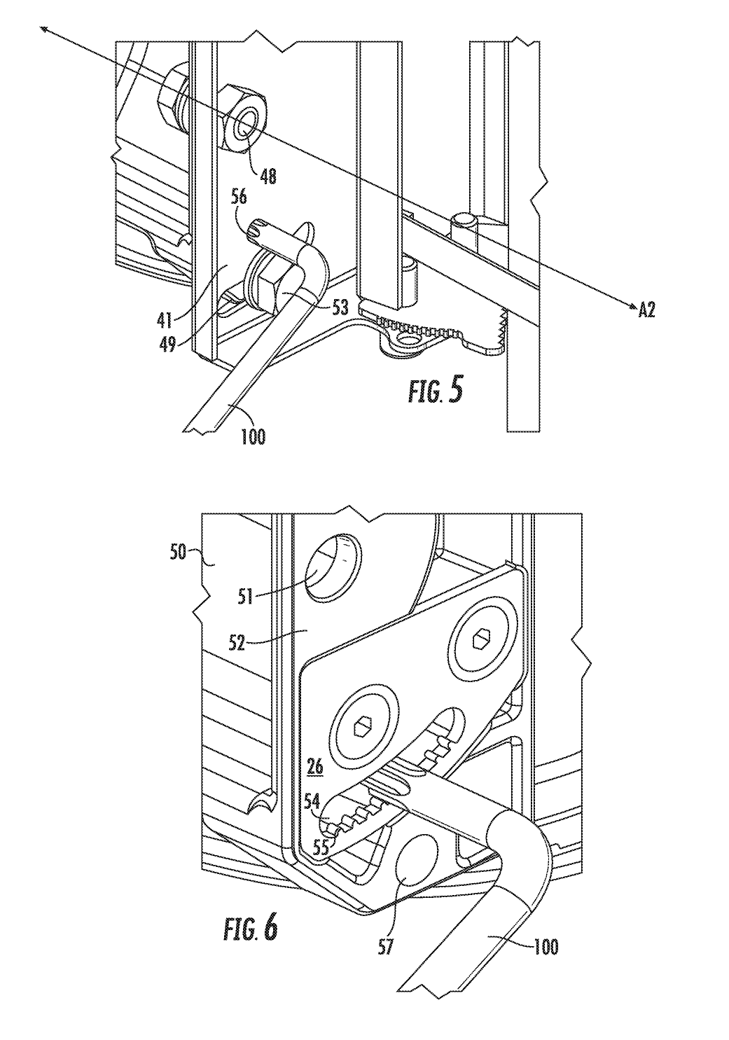

As further examples of suitable variations, FIGS. 3A, 3B,4A and 4B illustrate embodiments of azimuth adjustment brackets that may provide improved performance. In FIGS. 3A and 4A, two stabilizing members 70 are fixed via bolts 44′, 46′ to the end walls 43′ of the azimuth adjustment bracket 24′ in a manner that sandwiches the end walls 33′ of the clamp member 22′. A hole 72 is present in each stabilizing member 70 that is aligned with the access hole 47′ of the azimuth adjustment bracket 24′. Also, the end walls 33′ of the clamp member 22′ extend sufficiently that a slot 37a is formed, within which the teeth 37′ are present. As can be seen in FIGS. 3A and 4A, the torx tool 100 is inserted through the access hole 47′, the slot 37a and the hole 72 to adjust the azimuth angle of the antenna. The presence of the stabilizing member 70 support and stabilizes the torx tool 100 as it rotates, thereby providing more consistent engagement with the teeth 37′. In addition, the stabilizing member 70 can improve clamping of the azimuth adjustment bracket 24′ to the clamp member 22′ when the bolts 44′, 46′ are tightened. FIGS. 3B and 4B illustrate another alternative azimuth adjustment bracket 24″ in which the extension of the end wall 43″ on which the access hole 47″ is located is considerably longer and is “folded over” as a flange 76 to sandwich the portion of the end wall 33″ of the clamp member 22″ in which the toothed section 36″ is located. Another access hole 74 is present in the flange 76 of the extension. The torx tool 100 is inserted into the access holes 47″, 74 and engages with the teeth 37″; the torx tool 100″ is supported and stabilized by the flange 76 in much the manner as the stabilizing member 70 of the azimuth bracket 24′ in FIGS. 3A and 4A.

Also, those skilled in this art will appreciate that another hand tool (such as a spline tool) may be used instead of the torx tool 100 to adjust the azimuth and elevation angles of the antenna. A torx tool may be desirable given its popularity and common usage for other tasks, as a technician is likely to have a torx tool in a standard tool box. Typically, a torx tool has six teeth of about 3-4 mm pitch on its ends; as such, the teeth of the toothed sections 36, 55 of the clamp member 32 and the elevation adjustment bracket 26 should approximately match the same pitch. The torx tool 100 is also typically between about 7 mm and 9 mm in nominal diameter at its toothed ends. Nonetheless, a torx tool sized from T1 (under 1 mm diameter) to T100 (19 mm diameter) may be used, with sizes T40 and T50 being commonly used.

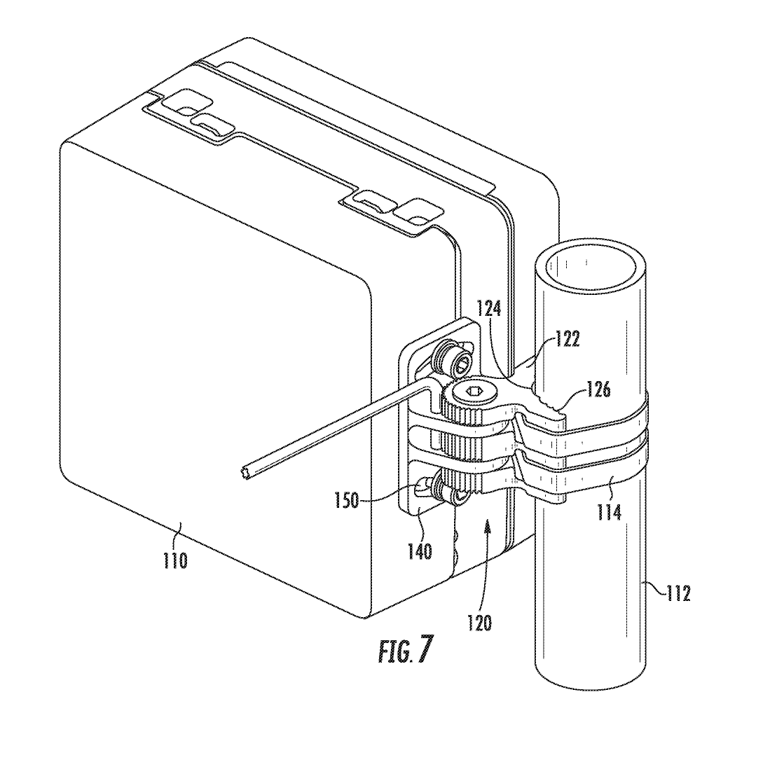

Another embodiment of an azimuth-adjustable antenna mount, designated broadly at 120, is shown in FIGS. 7 and 8. An antenna 110 is mounted to a pole 112 via the antenna mount 120, with straps 114 wrapped around the pole 112 and a portion of the mount 120.

The antenna mount 120 has a vertical clamp member 122 with teeth 126 on a curved clamping surface 124 that engage the pole 120. The clamp member 122 also has three spaced projections 128, each with a partially conical hole 129, that extend away from the clamping surface 124. Each of the projections 128 has teeth 130 on an arcuate edge 132 (in some embodiments, the teeth 130 may be formed via extrusion). An azimuth adjustment bracket 140 is mounted to the antenna 110. The azimuth adjustment bracket 140 includes two extensions 142 that fit within the gaps between the projections 128 of the clamp bracket 122. Each extension 142 has an access hole 144 adjacent the teeth 130. A bolt 152 is inserted through the holes 129 in the projections 128 and the extensions 142 to define a vertical axis A3. The azimuth adjustment bracket 140 is mounted to the antenna 110 via bolts 146 that are inserted into two arcuate slots 150.

As can be seen in FIG. 8, a spline tool 100′ can be inserted into the access hole 144 of one of the extensions 142, which causes the teeth 102′ of the spline tool 100′ to engage the teeth 130 of two of the projections 128 of the clamp bracket 122. Rotation of the spline tool 100′ rotates the azimuth adjustment bracket 140 relative to the clamp member 122, thereby adjusting the azimuth of the antenna 110. When the antenna 110 has reached the proper azimuth angle, the bolt 152 can be tightened to secure the antenna 110 in place. Also, the elevation of the antenna 110 can be adjusted by rotatably shifting the antenna 110 relative to the azimuth adjustment bracket 140 along the path defined by the bolts 146, then tightening the bolts 146. Those skilled in this art will recognize that the elevation adjustment could also be carried out in the same manner described above with respect to the antenna mount 20 with elevation adjustment brackets attached to the antenna 110.

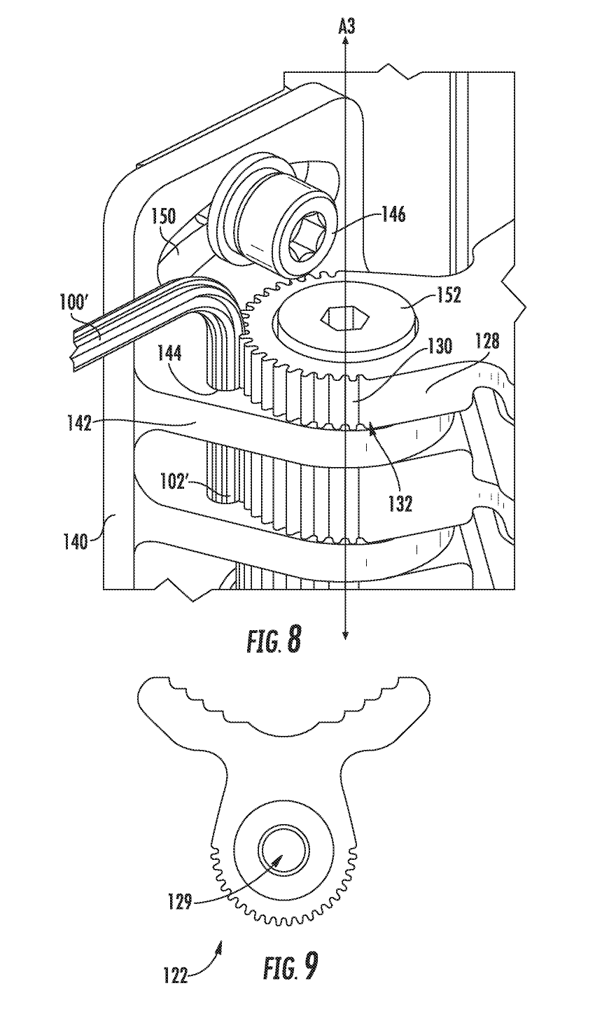

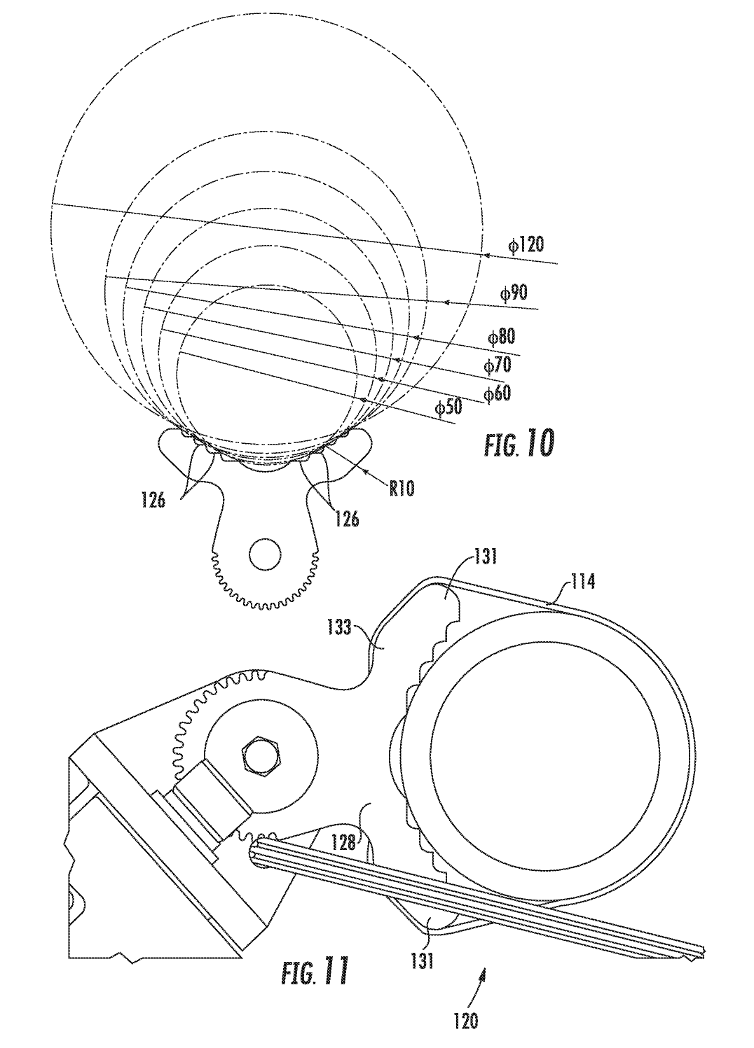

Several aspects of the clamp member 122 and the should be noted. As shown in FIG. 9, the hole 129 in the top projection 128 is partially conical, which allows the use of a countersunk bolt 152. The countersunk bolt 152 can help to reduce the size of the mount 120 and provide easier access to the bolts 146 that adjust elevation. Also, the use of a conical hole 129 helps to reduce and/or minimize radial movement of the azimuth adjustment bracket 140 relative to the clamp member 122. Also, as shown in FIG. 11, the free ends 131 and medial edges 133 of the projections 128 are rounded (a minimum radius of at least 5 mm may be desirable) to reduce stress on the straps 114 mounting the antenna mount 120 in place.

Further, as illustrated in FIGS. 9 and 10, the profile of the teeth 126 on the clamp member may be selected to enable clamping with a wide range of pole diameters. It may desirable that at least four teeth 126 of the clamp member 122 contact the pole 112, particularly if the pole 112 is of a small diameter. As shown in FIGS. 9 and 10, the use of teeth 126 that are somewhat more densely spaced near the free ends 131 of the projections 128 than near the center of the projections 128 can permit the clamp member 120 to clamp poles 112 with diameters ranging from 50-80 mm with at least the desired four teeth 126, and larger poles 112 with at least two teeth 126.

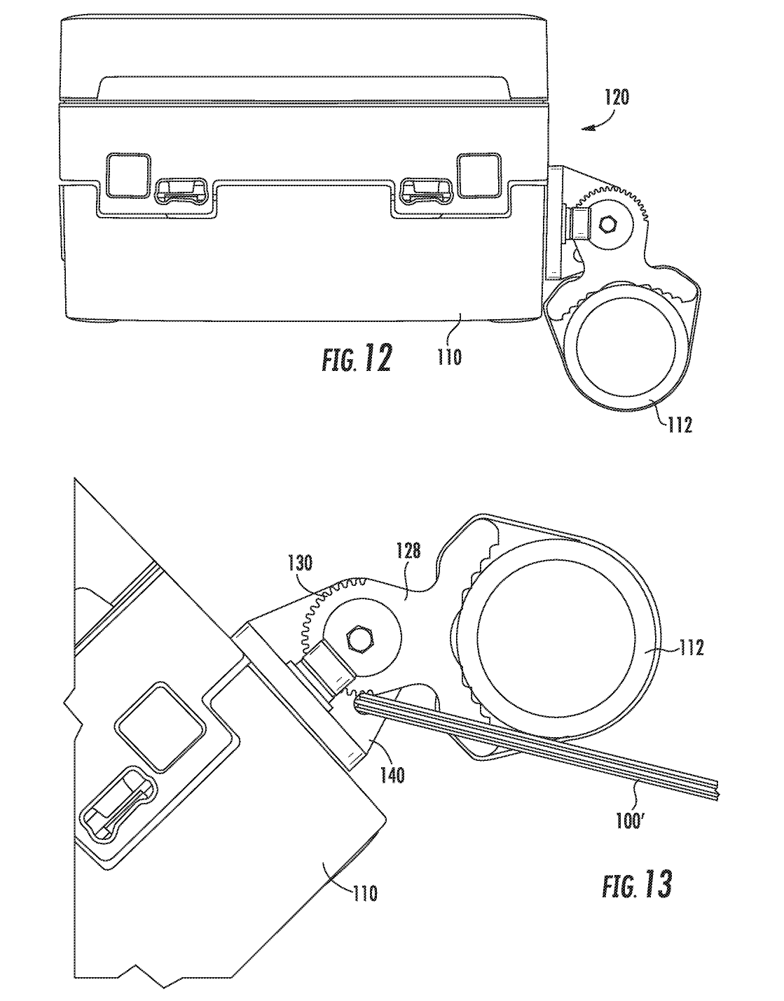

In addition, the antenna mount 120 may be configured to prevent mounting of the antenna 110 in front and to the side of the antenna (in the manner shown in FIG. 12), as this relative positioning of the antenna 110, the antenna mount 120 and the pole 112 can interfere with the RF signal and adversely affect antenna performance. The antenna position may be controlled by inhibiting the angular range over which the antenna 110 can be rotated relative to the clamp member 122. As shown in FIG. 13, the teeth 130 of the projections 128 may be arranged so that the spline tool 100′ cannot rotate the azimuth adjustment bracket 140 to an angle that would position the antenna 110 behind the pole 112.

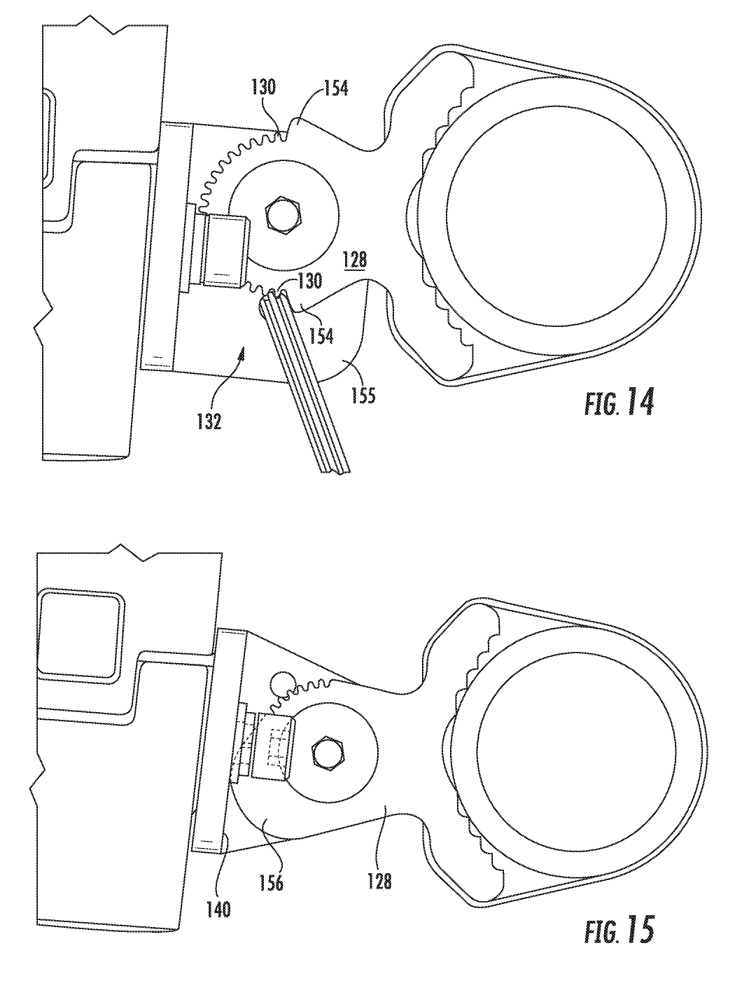

Alternatively, the projections 128 may include small protrusions 154 on the edge 132 adjacent the outermost teeth 130 that engage with the spline tool 100′ and prevent further rotation (FIG. 14). This embodiment also includes a lobed corner 155 on the azimuth adjustment bracket 140 that can engage one of the arms of one of the projections 128 (the lobed corner 155 may be vertically offset slightly to ensure engagement with the projection 128). As another alternative, one or more of the projections 128 may have a lobe 156 that engages the azimuth adjustment bracket 140 (FIG. 15), or pins 158 may protrude from the projections 128 to engage the azimuth adjustment bracket 140 (FIG. 16). Other variations of structure that can prevent rotation beyond a preselected angle may be apparent to those of skill in this art.

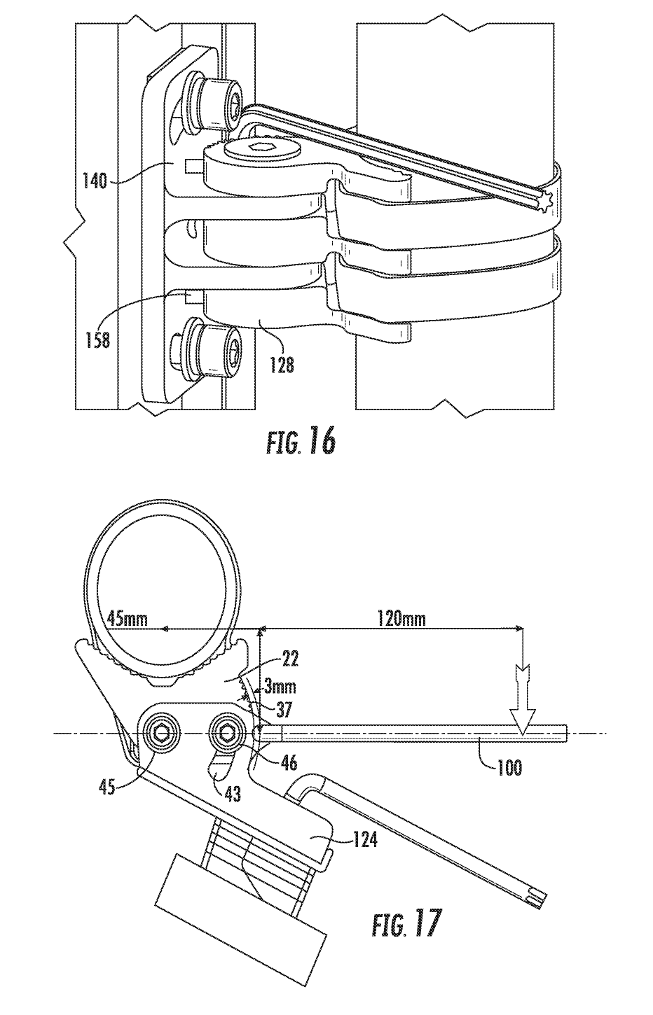

Because the torx and spline tools 100, 100′ are relatively small in its circumference/diameter, a relatively large angular rotation of the torx/spline tools 100, 100′ is required to pivot the azimuth and elevation adjustment brackets 24, 26 and/or the azimuth adjustment bracket 140. As such, accurate fine adjustments can be made relatively easily. The following example demonstrates the precision that can be achieved with a standard torx tool (refer also to FIG. 17).

1. Torx Tool:
120 mm arm (the length of the torx tool) applied to 3 mm nominal radius of the shorter end of the torx tool (120:3=40:1 ratio)
10 mm movement at the end of the arm of the torx tool=4.8° rotation of torx tool about the axis through the shorter end of the torx tool [360°×10 mm/(2π120 mm)]

2. Mount Geometry:
Access hole for torx tool creates 45 mm radius from pivot axis to teeth=ratio of (45 mm−3 mm)/3 mm=14:1 ratio
Therefore 4.8° movement of torx tool is equivalent to 4.8°/14=0.34° movement of mount

3. Combined Effect:
Combined reduction ratio=40:1×14:1=560:1
10 mm movement at the end of the Torx Tool will adjust the Antenna by 0.34°

Note that the typical alignment precision required for an antenna is related to the 0.3×3 dB beamwidth of the antenna, and this value for an 80 GHz, 1 ft antenna is 0.3°. As such, the precision calculated above should be effective for proper adjustment of the azimuth and elevation angles of antennas mounted on the antenna mounts shown herein.

Those skilled in this art will appreciate that other gear ratios and radius ratios may also be used. For example, the ratio of (a) the radius between the pivot axis and the toothed section and (b) the radius of the end of the torx tool may be between about 5:1 and 25:1, and in some embodiments, a ratio of 10:1 to 20:1 may be used.

Those skilled in this art will also appreciate that the arrangements illustrated and described herein may be applicable to devices other than antennas that require precise alignment. For example, in free space optical communications, the communication links employ lasers rather than antennas, and such lasers require precise angular alignment. The concepts discussed herein may be used in conjunction with such equipment to precisely align devices of this sort. Other devices and environments may be apparent to those of skill in this art.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. A method of adjusting the pointing angle of an antenna, comprising:
mounting an antenna on a mounting structure with an antenna mount, the antenna mount including a clamp member fixed to the mounting structure, a first adjustment bracket pivotally attached to the clamp member, and a second adjustment bracket pivotally attached to the first adjustment bracket, the antenna being mounted to the second adjustment bracket;
wherein at least one of the first and second adjustment brackets includes an access hole for receiving a toothed hand tool, and wherein at least one of the clamp member, the first adjustment bracket and the second adjustment bracket includes a toothed section;
inserting a toothed hand tool through the access hole to engage the toothed section; rotating the hand tool to pivot (a) the first adjustment bracket relative to the clamp member or (b) the second adjustment bracket relative to the first adjustment bracket; and
securing the pivoted first or second adjustment bracket in position to set the azimuth angle or elevation angle of the antenna.

2. The method defined in claim 1, wherein at least two of the clamp member, the first adjustment bracket and the second adjustment bracket include toothed sections, and wherein the one of the first and second adjustment brackets includes a second access hole.

3. The method defined in claim 2, wherein the first and second access holes are located on the first adjustment bracket, the clamping member includes one of the toothed sections, and the second adjustment bracket includes the other of the toothed sections.

4. The method defined in claim 3, wherein relative movement between the clamping member and the first adjustment bracket adjusts the azimuth of the antenna, and relative movement between the first adjustment bracket and the second adjustment bracket adjusts the elevation of the antenna.

5. The method defined in claim 1, wherein the toothed hand tool is a torx tool or a spline tool.

6. The method defined in claim 1, wherein a ratio between a radius of the toothed hand tool and a radius defined by the toothed section and a pivot point is between about 5:1 and 25:1.

7. (canceled)

8. (canceled)

9. An antenna mount, comprising:
a clamp member configured to be fixed to a mounting structure, the clamp member including a first toothed section;
an azimuth adjustment bracket pivotally attached to the clamp member at a first pivot; and
an elevation adjustment bracket pivotally attached to the azimuth adjustment bracket at a second pivot and including a second toothed section, the elevation adjustment bracket configured to be fixed to an antenna;
wherein the azimuth adjustment bracket includes first and second access holes for receiving a toothed hand tool and providing access for the hand tool to, respectively, the first and second toothed sections.

10. The antenna mount defined in claim 9, wherein a radius between the first toothed section and the first pivot and a radius of the first access hole define a ratio of between about 5:1 and 25:1.

11. The antenna mount defined in claim 9, wherein a radius between the second toothed section and the second pivot and a radius of the second access hole define a ratio of between about 5:1 and 25:1.

12. The antenna mount defined in claim 9, wherein a fastener is disposed between the clamp member and the azimuth adjustment bracket, the fastener configured to be secured to fix the antenna at a desired azimuth angle.

13. The antenna mount defined in claim 9, wherein a fastener is disposed between the clamp member and the elevation adjustment bracket, the fastener configured to be secured to fix the antenna at a desired elevation angle.

14. The antenna mount defined in claim 9, wherein one of clamp member, the azimuth bracket and the elevation bracket includes a stabilizing member with a hole aligned with the first or second access holes to stabilize the hand tool when it is inserted into the first or second access holes.

15. An antenna mount, comprising:
a clamp member configured to be fixed to a mounting structure, the clamp member including a toothed section;
an azimuth adjustment bracket pivotally attached to the clamp member at a first pivot; and
an elevation adjustment bracket pivotally attached to the azimuth adjustment bracket at a second pivot, the elevation adjustment bracket configured to be fixed to an antenna;
wherein the azimuth adjustment bracket includes an access hole for receiving a toothed hand tool and providing access for the hand tool to the toothed section.

16. The antenna mount defined in claim 15, wherein the clamp member includes a plurality of projections, and wherein the azimuth adjustment bracket includes a plurality of extensions that fit within gaps between the projections to form a stacked configuration of projections and extensions, and wherein the toothed section is located on an arcuate edge of at least one of the projections and the access hole is located on one of the extensions.

17. The antenna mount defined in claim 16, wherein the projections include structure to prevent rotation of the azimuth adjustment bracket relative to the clamp member beyond a preselected angle.

18. The antenna mount defined in claim 17, wherein the structure comprises a protrusion on the projection adjacent the toothed section that engages the hand tool to prevent undesired rotation.

19. The antenna mount defined in claim 17, wherein the structure comprises a member that engages the azimuth adjustment bracket to prevent undesired rotation.

20. (canceled)
